(19) United States
(12) Patent Application Publication
(10) Pub. No.: US 2016/0185026 A1
(43) Pub. Date: Jun. 30, 2016

(54) METHOD FOR PRODUCING A TWIN SCREW CYLINDER PROVIDED WITH A WEAR-PROTECTIVE LAYER

(71) Applicants: Peter BENDING, Köln (DE); Thomas PORSTNER, Lauf (DE)

(72) Inventors: Peter BENDING, Köln (DE); Thomas PORSTNER, Lauf (DE)

(21) Appl. No.: 14/909,255

(22) PCT Filed: Aug. 1, 2013
(86) PCT No.: PCT/EP2013/066179

§ 371 Date: Feb. 1, 2016

(51) Int. Cl. B29C 47/08; B29B 7/46; B29B 7/58; B29C 47/40; B29C 47/66

(52) U.S. Cl. CPC B29C 47/0849; B29C 47/40; B29C 47/662; B29B 7/58; B29B 7/46

(57) ABSTRACT

A method for producing a twin screw cylinder provided with or having a wear-resistant coating, in which two bores, which extend essentially parallel to each other and overlap each other, are produced in a cylinder and then two liners are inserted into the bores, the liners having an essentially C-shaped cross-section, continuing from each other in the overlapping region of the bores, forming the inner surface of the bores, and serving as a wear-resistant coating. First, a tubular liner is inserted into a first bore and then is cut to form the C-shaped cross-section in accordance with the diameter of the other bore and after this, a second tubular liner is inserted into the second bore and then is cut to form the C-shaped cross-section in accordance with the diameter of the inner surface in the first bore formed by the first liner.

### BACKGROUND OF THE INVENTION

1. Field of the Invention

This invention relates to a method for producing a twin screw cylinder having a wear-resistant coating, in which two bores, which extend essentially parallel to each other and overlap each other, are produced in a cylinder and then two liners are inserted into the bores, and the liners have an essentially C-shaped cross-section, continuing from each other in the overlapping region of the bores, forming an inner surface of the bores, and serving as a wear-resistant coating.

2. Discussion of Related Art

Twin screw cylinders are used in twin screw extruders in plastics processing and accommodate the extruder screws. Various methods for producing known twin screw cylinders are known, for example from U.S. Pat. No. 3,277,529, U.S. Pat. No. 3,268,949, U.S. Pat. No. 3,010,151, and German Patent Reference DE 2231046 A1.

In the known twin screw cylinders, the wear-resistant coating is embodied so that first, the bores are produced in the cylinders, which subsequently accommodate the screws of a twin screw extruder, and in a separate work step, the essentially C-shaped liners with their open sections, which are oriented toward the subsequent overlapping region of the bores, are aligned with each other and in this region, are attached to each other by weld seams or the like. The one-piece liner, which is thus adapted to the overlapping bores, is then inserted into the bores in the cylinders through the exertion of more or less powerful pressure so that the liners constitute or form the inner surface of the bores and serve as a wear-resistant coating.

This above-explained technique has stood the test of time for many years, but requires a considerable amount of manual labor and in the event that the wear-resistant coating becomes worn with use, which usually occurs only in some areas, requires replacement of the entire cylinder or at least the liner that constitutes or forms the entire wear-resistant coating.

### SUMMARY OF THE INVENTION

One object of this invention is to provide, based on the prior art mentioned at the beginning, a method for producing a twin screw cylinder provided with or having a wear-resistant coating, which can be carried out with less effort and which introduces the possibility of selectively replacing worn sections of the twin screw cylinder.

In order to attain the above object according to this invention, a method according to this invention has features discussed in this specification and in the claims.

Advantageous embodiments and modifications of the method according to this invention are discussed in this specification and in the claims.

A twin screw cylinder, which is produced according to this invention and is intended for a corresponding twin screw extruder, and advantageous modifications and embodiments are discussed in this specification and in the claims.

In order to attain the stated object according to this invention, this invention provides, such as known in the prior art, first, the two bores, which extend essentially parallel to each other and overlap each other, in a cylinder.

In the context of this invention, “bores, which extend essentially parallel to each other and overlap each other” are understood to be both bores that extend exactly parallel to each other and bores that extend at an acute angle to each other, as is the case when using conical screws for a corresponding twin screw extruder.

According to this invention, after the overlapping bores are produced in the cylinder, first a tubular liner, such as a liner in the form of a preferably closed tube, is inserted into a first bore and is then cut to form the C-shaped cross-section thereof in accordance with the diameter of the other bore, which has not yet been provided with a liner. In this way, in a first step, the first bore is provided with the liner that constitutes or forms the wear-resistant coating, which liner is in particular closed at first, and is then cut or trimmed in the subsequent overlapping region of the bores, in accordance with the diameter of the other bore. The piece of the liner that has been cut off here is either discarded or recycled.

After the first bore has thus been provided with the liner with the C-shaped cross-section, which because it is cut in accordance with the diameter of the second bore, extends this second bore in the overlapping region, a corresponding tubular, preferably closed liner is then also inserted into the second bore and is then cut in the overlapping region, forming a C-shaped cross-section, in accordance with the diameter of the inner surface of the first bore formed by the first liner. Here, too, the piece of the liner that has been cut off is either discarded or recycled.

This yields a twin screw cylinder, which as in the prior art, has two bores extending essentially parallel to each other and overlapping each other and which is provided with or has a wear-resistant coating in the form of two liners that are essentially C-shaped and continue each other in the overlapping region of the bores.

Using the method according to this invention thus yields advantages.

First, inserting the respective single liners into the bores provided for them is significantly easier than inserting a pre-attached liner composed of two cross-sections that are welded to each other.

Second, the method proposed according to this invention does not require a welding of the liners that are inserted into the bores.

Instead, when the liners are made of a bimetallic material according to one embodiment of this invention, this invention particularly makes use of the effect that the initially tubular liners, after being inserted into the bores provided for them and being cut in the overlapping region, due to inherent stresses, tend to spread open so that a force directed radially outward is exerted on the associated bore, which allows the liner to automatically clamp in place inside the bore and eliminates previously inevitable air gaps between the liner and the bore, thus significantly improving the thermal conductivity and also significantly improving the measurement result of a temperature sensor that is inserted into the cylinder.

Because the special cut guidance during the cutting of the first and second liner also ensures that the first liner comes to rest or rests against the second liner in abutting fashion, the above-explained forces within the cut liners, which are responsible for their tendency to spread open, cause the free ends of the C-shaped cross-sections of the two liners to press against each other in the region of or near their butt joint so that it is no longer necessary to weld the two liners, which results in enormous reduction in the amount of manual labor required to produce the twin screw cylinder with the method according to this invention.

It is also possible for a rotation prevention means, such as in the form of at least one feather key that is secured in corresponding feather key recesses in the bore and the liner, to be inserted between the bores and the liners, before or after the cutting of the liners. These rotation preventions prevent an unwanted displacement of the liner in the tube accommodating it, during or after the cutting of the liner.

In order to improve the uniform, firm contact of the free ends of the two liners against each other, according to another proposal of this invention, before the insertion of the second liner, the cut surface that will subsequently rest in abutting fashion against the second liner and/or the inner surface of the first liner can be surface ground in order to embody or form it precisely with regard to dimensional consistency and angularity.

The cutting of the liner can in principle be carried out with any available method, according to this invention, a cutting by wire erosion is considered to be particularly feasible.

Furthermore, the method according to this invention makes it possible to assemble the twin screw cylinder out of a plurality of segments that extend one another, which each include only a subsection of the bores, and before the assembly, are each provided with sections of the liners in the above-described way. For example, it is possible to produce segments with a length of at most 500 mm and to provide them with respective liners of a corresponding length in the manner according to this invention so that these compact segments can be easily maneuvered in the usual machines for drilling, grinding, eroding, and so forth before the entire twin screw cylinder is assembled from the individual elements thus produced.

The assembly can, for example, be achieved by accurately positioned pre-attachment of the segments and subsequent welding thereof to produce the twin screw cylinder.

It is also possible, after the sections are assembled, to hone the twin screw cylinder in the region of its entire inner surface, such as completely, in order to achieve a uniform surface for accommodating the extruder screws.

In the case of this segmented embodiment of the twin screw cylinder, it is possible in the event of wear to selectively replace the worn segments, such as to remove them by cutting the welded connections or cutting them at any other position and to replace them with corresponding new segments and to remove the worn liner from this removed segment, replace it, and then to re-insert the thus renovated segment back into the twin screw cylinder. This significantly reduces the cost for repairing a worn twin screw cylinder.

### BRIEF DESCRIPTION OF THE DRAWINGS

Other embodiments and details of this invention are explained in greater detail in view of an exemplary embodiment that is shown in the drawings, wherein:

FIG. 1 shows a view of a twin screw cylinder produced using the method according to this invention;

FIGS. 2a and 2b show two successive work steps in the production of the twin screw cylinder according to FIG. 1;

FIG. 3 shows a longitudinal section taken through a segment of the twin screw cylinder according to FIG. 1; and

FIG. 4 shows a longitudinal section taken through a twin screw cylinder according to this invention that is assembled out of individual segments.

### DETAILED DESCRIPTION OF THE INVENTION

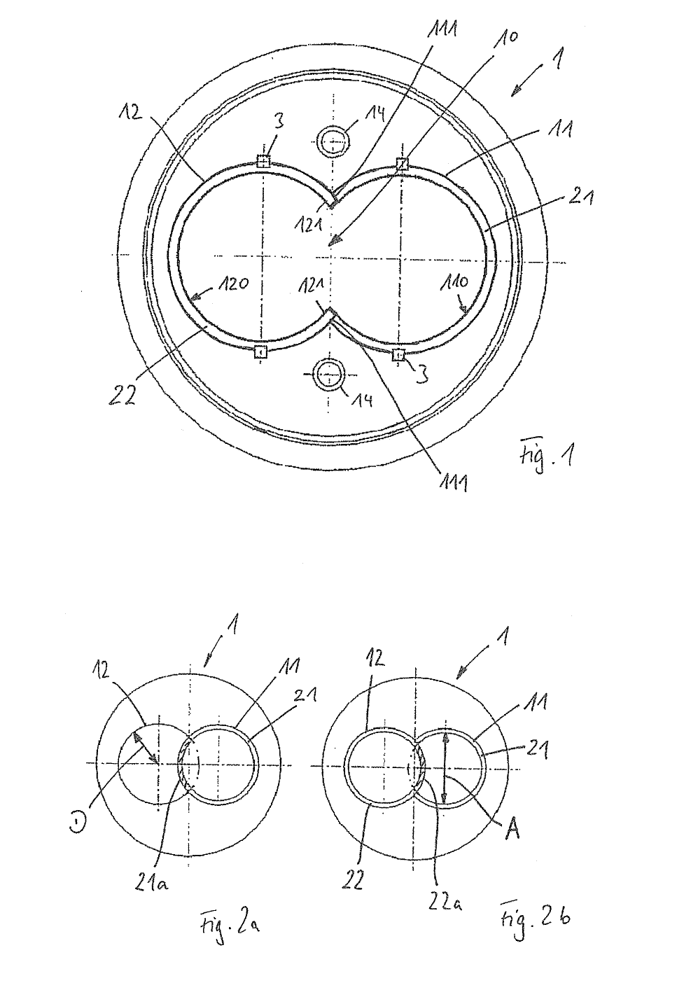

FIG. 1 shows a twin screw cylinder that is labeled as a whole or in its entirety with the reference numeral 1, which in an intrinsically known fashion, has a cylindrical base body produced from a suitable metallic material as a component of a corresponding twin screw extruder for plastics processing, in which two bores 10, 11 are produced, which in the exemplary embodiment shown, extend exactly parallel to each other and are of the same diameter in such a way that they overlap each other and thus define an overlapping region 10.

Each of the two bores 11, 12 is provided with or has a liner 21, 22 that has an essentially C-shaped cross-section, which liners continue or form each other in the overlapping region 10 so that the liners 21, 22 cover the entire inner surface of the bores 11, 12. The liners 21, 22 in this case are composed of or of a suitable, for example bimetallic, material and serve as a wear-resistant coating for the screws of the twin screw extruder, which are to be accommodated inside the inner surfaces 110 and 120 and are not shown here.

As shown in FIG. 1, it is clear that contrary to the prior art, the two liners 21, 22 are not welded to each other in the overlapping region 10, such as in the region in which they continue each other, but instead, the free ends 111, 121 are positioned relative to each other so that the free ends 111 of the liner 21 contact the free ends 121 of the liner 12 in abutting fashion.

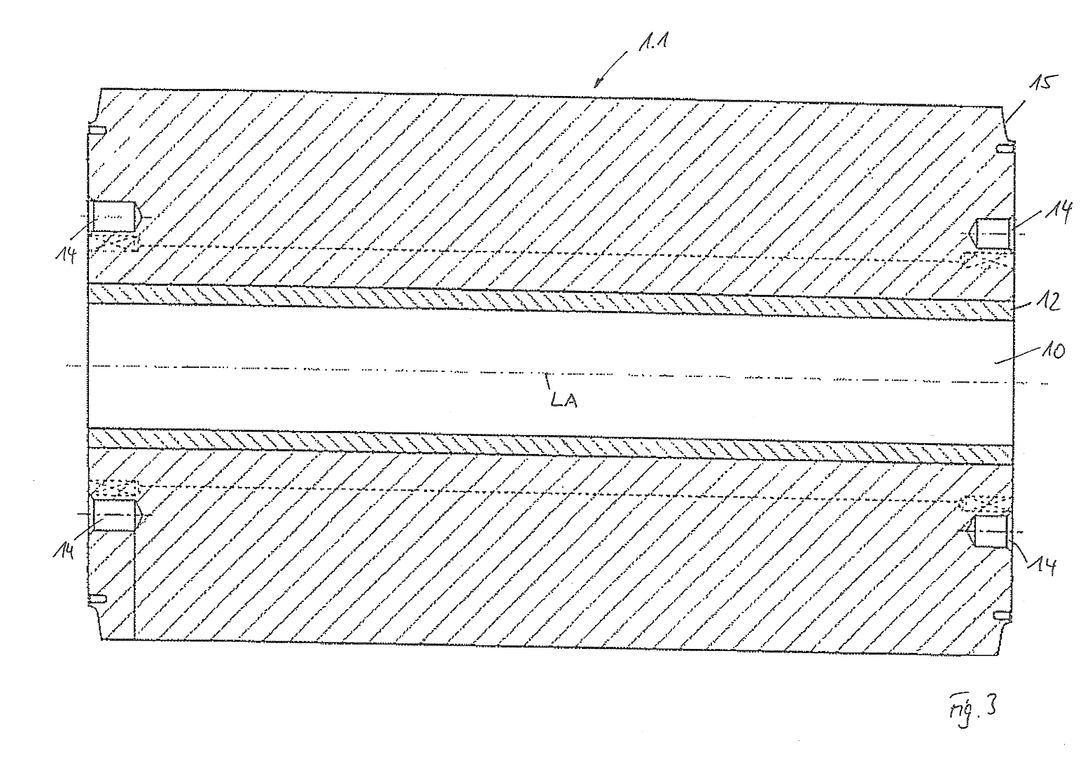

The production of such a twin screw cylinder, which is shown in FIG. 1, will be explained below in conjunction with FIGS. 2a and 2b.

In a first step, the two bores 11, 12 are produced in an intrinsically known fashion in the cylinder, parallel to each other with the diameter D, which compared to the final inner diameter of the bores 11, 12 that is finally required in order to accommodate the screws, is oversized in accordance with the thickness of the liners 21, 22.

Then, as shown in FIG. 2a, the first liner 21 is inserted into the associated right bore, which in this case is referred to as the first bore 11, for example, this liner, however, is initially embodied in the form of a closed tube with the outer diameter D. The insertion is carried out by sliding the liner 21 axially into the bore 11.

Then, the liner 21 is cut, such as by wire erosion, in accordance with the diameter D of the second, left bore 12, such as along the imaginary extension of the diametrical curve of the diameter D in the overlapping region 10 so that the segment 21a that is shown in crosshatched fashion in FIG. 2a is cut off and removed. A C-shaped liner of the first bore 11 remains, whose free ends 111 come to an end in the overlapping region 10 of the two bores 11, 12.

In order to prevent relative movement of the liner 21 inside the bore 11 during the cutting, the feather keys 3 that are visible in FIG. 1 are inserted between the bore 11 and the liner 21 before the liner 21 is cut in the above-described fashion.

Since the liner 21, as mentioned above, is preferably composed of or of a bimetallic material, after the cutting and removal of the segment 21 a, the liner tends to spread open radially and exerts a corresponding radial force on the surface of the bore 11, which is accompanied by an automatic clamping effect and the elimination of any air gaps between the bore 11 and the liner 21.

Then the second liner 22, which is likewise initially in the form of a closed tube with a diameter D, is inserted into the still unoccupied second bore 12 as shown in FIG. 2b, such as is likewise slid into it axially and then, the segment 22a of the liner 22 that is shown in crosshatched fashion in FIG. 2b is cut in accordance with the curve of the inner diameter A of the first liner 21, such as by wire erosion, causing the second liner 22 to also be cut in a way that produces a C-shaped cross-section. Here, too, the liner 22 tends to spread open radially so that an automatic clamping in the bore 12 occurs and furthermore, aligning pins 3 prevent the liner 22 from moving inside the bore 12 before the latter is cut.

This therefore yields the configuration shown in FIG. 1 in which the two liners 21, 22 constitute or form the inner surfaces 110, 120 of the bores 11, 12 and serve as wear-resistant coatings. The free ends 111 of the first liner 21 contact the free ends 121 of the second liner 22 in abutting fashion, such as the free ends 111, 121 are approximately at right angles to each other.

As a result of the above-mentioned tendency to spread open radially, the abutting surface between the free ends 111, 121 is subjected to a corresponding surface pressure so that no unwanted material, such as molten material, can penetrate through from the screws accommodated in the bores and for this reason, the two liners 21, 22 do not have to be welded to each other in the overlapping region 10.

Naturally, in order to further improve the contact pressure between the free ends 111, 121, it is possible, after the cutting of the first liner 21 and removal of the segment 21a, to additionally grind the cut surfaces and/or the inner surface 110 of the liner 21 so as to ensure their dimensional consistency and angularity.

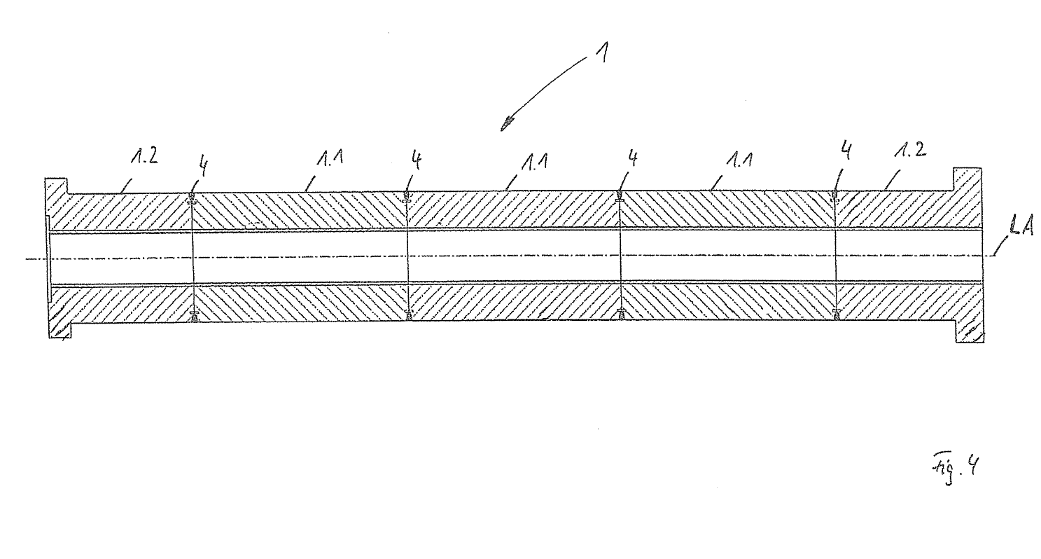

As is particularly clear from the depiction in FIGS. 3 and 4, the above-described method according to this invention for inserting into the bores 11, 12 the liners 21, 22 that serve as the wear-resistant coating makes it possible to produce the twin screw cylinder 1 from a plurality of segments, as clearly shown in FIG. 4. Consequently, the whole or entire twin screw cylinder 1 includes a plurality, in this case three, for example, cylindrical segments 1.1, one of which is shown in an enlarged view in FIG. 3, as well as additional segments 1.2 at each of the ends, which are each provided with a molded-on flange, but which are otherwise embodied in a fashion comparable to that of the segment 1.1 according to FIG. 3.

For example, each of these segments has a length of at most 500 mm so that all of the above-mentioned work steps such as boring, erosion, and grinding can be carried out using commercially available machine tools and with a minimum effort for transport and lifting gear. Each individual segment 1.1, 1.2 contains a section of the bores 11, 12 that are each equipped in the above-explained way with corresponding liners 11, 12 that are the length of the section and in cross-section, have the configuration according to FIG. 1.

Then the individual segments are attached to each other as shown in FIG. 4 by weld seams 4 so that the individual longitudinal axes LA of the segments complete a shared longitudinal axis LA of the twin screw cylinder 1 and are aligned with one another.

The alignment and pre-attachment of the segments 1.1, 1.2 to one another is facilitated by receiving bores 14 for centering pins and the like. In addition, chamfers 15 are provided for the production of the welding seams 4. Naturally, after all of the segments have been assembled to produce the twin screw cylinder 1 according to FIG. 4, a joint honing of the inner surfaces 110, 120 can be provided in order to ensure a uniform surface.

In addition to the above-mentioned facilitated maneuvering of the individual segments and the production of the bores 11, 12 and insertion of the liners 21, 22, the arrangement according to this invention also offers the advantage that individual worn segments can be selectively replaced by cutting the corresponding welded connections 4. In particular, the fact that the liners 21, 22 remain in contact with each other without welds also makes it possible to replace only individual liners 21, 22, for example, in the event of wear. This constitutes or forms an enormous reduction in the amount of work required to overhaul a twin screw cylinder 1 of this kind.

Naturally, the number of segments 1.1, 1.2 can vary depending on the length of the twin screw cylinder 1.

1. A method for producing a twin screw cylinder provided with a wear-resistant coating (1), in which two bores (11, 12), extending essentially parallel to each other and overlapping each other, are produced in a cylinder and then two liners (21, 22) are inserted into the bores (11, 12), the liners having an essentially C-shaped cross-section, continuing from each other in an overlapping region (10) of the bores (11, 12) forming an inner surface (110, 120) of the bores (11, 12), and serving as a wear-resistant coating the method including first inserting a tubular liner (21) into a first bore (11) and then cutting to form the C-shaped cross-section in accordance with a diameter (D) of the other bore (12), and then inserting a second tubular liner (22) into the second bore (12) and then cutting to form the C-shaped cross-section in accordance with a diameter (A) of the inner surface (110) in the first bore (11) formed by the first liner (21).

2. The method according to claim 1, wherein a rotation prevention is inserted between the bores (11, 12) and the liners (21, 22) before or after the cutting of the liners (21, 22).

3. The method according to claim 2, wherein the rotation prevention is in a form of at least one feather key (3) inserted into corresponding feather key recesses in the bore (11, 12) and the liner (21, 22).

4. The method according to claim 3, wherein before the insertion of the second liner (22), a cut surface and/or the inner surface of the first liner (21) is/are ground.

5. The method according to claim 4, wherein the liners (21, 22) are composed of a bimetallic material and after the cutting exert a radially outward-directed force on the associated bore (11, 12).

6. The method according to claim 5, wherein the cutting of the liners (21, 22) is carried out by wire erosion.

7. The method according to claim 6, wherein the twin screw cylinder (1) is assembled from a plurality of segments (1.1, 1.2) that extend one another, which each include only a subsection of the bores (11, 12) and before the assembly, each have sections of the liners (21, 22).

8. The method according to claim 7, wherein the segments (1.2, 1.2) are pre-attached to one another in an accurately positioned fashion and then are welded to produce the twin screw cylinder.

9. The method according to claim 8, wherein after the assembly of the segments (1.1, 1.2), the twin screw cylinder (1) is honed in a region of its inner surface.

10. A twin screw cylinder (1) having two bores (11, 12) extending essentially parallel to each other and overlapping each other, which in the region of their inner surface have a wear-resistant coating of two liners (21, 22) that are inserted into the bores (11, 12), the liners having an essentially C-shaped cross-section and continuing from each other in the overlapping region (10) of the bores (11, 12), the twin screw cylinder (1) comprising a first liner (21) resting against the second liner (22) in an abutting fashion.

11. The twin screw cylinder (1) according to claim 10, wherein the first liner (21) has a C-shaped cross-section with free ends (111) come to an end on an imaginary circumference line of a diameter (D) of the adjacent bore (12) and the second liner (22) has a C-shaped cross-section with free ends (121) coming to an end on the imaginary circumference line of the inner diameter (A) of the first liner (21).

12. The twin screw cylinder (1) according to claim 11, comprising a plurality of segments (1.1, 1.2) that continue one another, each of which contains a section of the bores (11, 12) that are provided with the wear-resistant coating.

13. The twin screw cylinder (1) according to claim 12, wherein at least one rotation prevention is provided between the bores (11, 12) and the liners (21, 22) that are inserted into them.

14. The twin screw cylinder (1) according to claim 13, wherein the rotation prevention is formed as a feather key (3).

15. The method according to claim 1, wherein before the insertion of the second liner (22), a cut surface and/or the inner surface of the first liner (21) is/are ground.

16. The method according to claim 1, wherein the liners (21, 22) are of a bimetallic material and after the cutting exert a radially outward-directed force on the associated bore (11, 12).

17. The method according to claim 1, wherein the cutting of the liners (21, 22) is carried out by wire erosion.

18. The method according to claim 1, wherein the twin screw cylinder (1) is assembled from a plurality of segments (1.1, 1.2) that extend one another, which each include only a subsection of the bores (11, 12) and before the assembly, each have sections of the liners (21, 22).

19. The method according to claim 18, wherein the segments (1.2, 1.2) are pre-attached to one another in an accurately positioned fashion and then are welded to produce the twin screw cylinder.

20. The method according to claim 1, wherein after the assembly of the segments (1.1, 1.2), the twin screw cylinder (1) is honed in a region of its inner surface.

21. The twin screw cylinder (1) according to claim 10, comprising a plurality of segments (1.1, 1.2) that continue one another, each of which contains a section of the bores (11, 12) that are provided with the wear-resistant coating.

22. The twin screw cylinder (1) according to claim 10, wherein at least one rotation prevention is provided between the bores (11, 12) and the liners (21, 22) that are inserted into them.

23. The twin screw cylinder (1) according to claim 22, wherein the rotation prevention is formed as a feather key (3).
